(19) United States
(12) Patent Application Publication
(10) Pub. No.: US 2003/0070523 A1
(43) Pub. Date: Apr. 17, 2003

(54) Paper punch

(76) Inventor: Yi-Jen Lin, Taipei (TW)

Correspondence Address: BACON & THOMAS, PLLC, 625 SLATERS LANE, FOURTH FLOOR, ALEXANDRIA, VA, 22314

(21) Appl. No.: 10/229,115

(22) Filed: Aug. 28, 2002

(30) Foreign Application Priority Data
Oct. 16, 2001 (TW) 090217618

(51) Int. Cl. B26D 1/12; B26F 1/14

(52) U.S. Cl. 83/669; 83/686

(57) ABSTRACT

The invention relates to a paper punch comprising a cover having a push button movably projected from the top, and a cutter coupled to the push button and having a longitudinal hole therethrough; a substantially parallelepiped base being coupled to the cover and having a second opening on the top for permitting the cutter to pass through and a receiving space in communication with the second opening; and a central needle in the receiving space passed through the second opening and being operable to punch a sheet of paper placed on the base and to secure the sheet of paper to the base so that the cutter is moved as the push button is pressed down, and in response, the needle moves into the longitudinal hole to activate the cutter for cutting the sheet of paper.

### FIELD OF THE INVENTION

The present invention relates to office supplies and more particularly to a paper punch with improved characteristics.

### BACKGROUND OF THE INVENTION

A conventional paper punch is shown in FIG. 1 and comprises a base 10 having at least one rounded recess 11 on the top surface, at least one raised member 12 on top of the base 10 adjacent the rounded recess 11, a seat 13 having one portion coupled to top of the raised member 12, a gap 14 having a height equal to that of the raised member 12 formed between another portion of the seat 13 and the top surface of the base 10, a longitudinal hole 18 within the seat 13 disposed correspondingly to the rounded recess 11, a handle 16 pivotably coupled to the seat 13 by means of a pivot pin 15, at least one cutter 19 disposed in the handle 16 being operable to insert into the hole 18, and an elastic member 17 disposed within the handle 16 and the seat 13, the elastic member 17 being put on the pivot pin 15. In operation, first place a sheet of paper in the gap 14. Next, press the handle 16 to cause the cutter 19 to insert through the hole 18, the paper, and the rounded recess 11. As a result, a hole is punched on the paper.

However, the prior art paper punch suffered from several disadvantages. For example, as referring to FIG. 1 again, the paper punch can function satisfactorily by punching a hole on any desirable portion of a sheet of paper if the paper is small. Unfortunately, the paper punch can only punch a hole on a peripheral portion of a sheet of paper if the paper is large. Such drawback is caused by the undesired connection of the seat 13 and the base 10. Further, one time of punching is impossible if the number of the sheets of paper is relatively large, i.e., a thickness of such many sheets of paper is larger than the gap 14.

Hence, such many sheets of paper are required to be punched in batches. This is time consuming. Furthermore, in a worse case it is impossible of inserting a sheet of paper into the gap 14 because a thickness of the paper is larger than the gap 14. Moreover, the cutter 19 is installed in a position within the paper punch 1 of being impossible to remove. Hence, a replacement of one cutter 19 with a different sized cutter 19 for punching a different sized hole is prohibited.

Also, a replacement of a worn-out cutter 19 is prohibited. In other words, the malfunctioned paper punch 1 has to be discarded. This is not cost effective. In view of the above, the well known paper punch is limited in complying with a variety of papers to be punched. Further, it contradicts a high efficiency, high quality design principle of the current office supplies. Thus improvement exists.

### SUMMARY OF THE INVENTION

The invention relates to a paper punch comprising a cover including a push button movably projected from the top, a first opening on the bottom, and a cutter coupled to the push button, the cutter having a longitudinal hole therethrough; a substantially parallelepiped base being coupled to the cover, the base including a second opening on the top for permitting the cutter to pass through and a receiving space in communication with the second opening; and a central needle in the receiving space passed through the second opening, the needle being operable to punch a sheet of paper placed on the base and to secure the sheet of paper to the base so that the cutter is moved as the push button is pressed down, and in response, the needle moves into the longitudinal hole to activate the cutter for cutting the sheet of paper. As an end, the paper punching purpose is achieved. By utilizing this paper punch, it is possible of overcoming the above drawbacks of the prior art which are that the well known paper punch can only punch a predetermined sized and shaped hole on a peripheral portion of a sheet of paper if the paper is large; and one time of punching is impossible if the number of the sheets of paper is relatively large, i.e., too thick.

In an aspect of the present invention, the cover further comprises a first upper seat, a first removable plate, a bottom opening facing the base, two opposite first grooves on the sides of the bottom opening, and two first rails on the sides of the first removable plate being slidingly engageable with the first grooves. Thus, the first removable plate may be disengaged from the bottom of the cover to replace a worn-out elastic member due to elasticity fatigue with a new one.

In another aspect of the present invention, the base further comprises a second upper seat, a second removable plate with the second opening formed thereon, a top opening on the second upper seat facing the cover, two opposite second grooves on the sides of the top opening, and two second rails on the sides of the second removable plate being slidingly engageable with the second grooves. Thus, a user can install one of various replaceable cutters in the push button. Next, the user removes the second removable plate having the second opening cooperated with the cutter. As an end, one of different sized holes can be punched on the sheet of paper.

The above and other objects, features and advantages of the present invention will become apparent from the following detailed description taken with the accompanying drawings.

### BRIEF DESCRIPTION OF THE DRAWINGS

FIG. 1 is a side view in part section of a conventional paper punch;

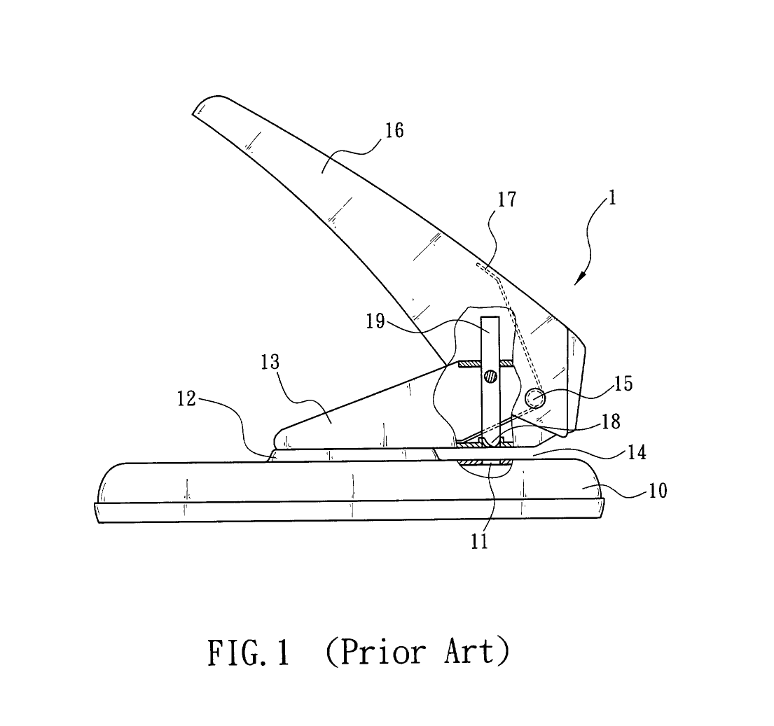

FIG. 2 is an exploded view of a preferred embodiment of a paper punch according to the invention;

FIG. 3 is a cross-sectional view of the assembled paper punch; and

FIG. 4 is a perspective view of four paper punches in an operative state.

### DETAILED DESCRIPTION OF THE PREFERRED EMBODIMENTS

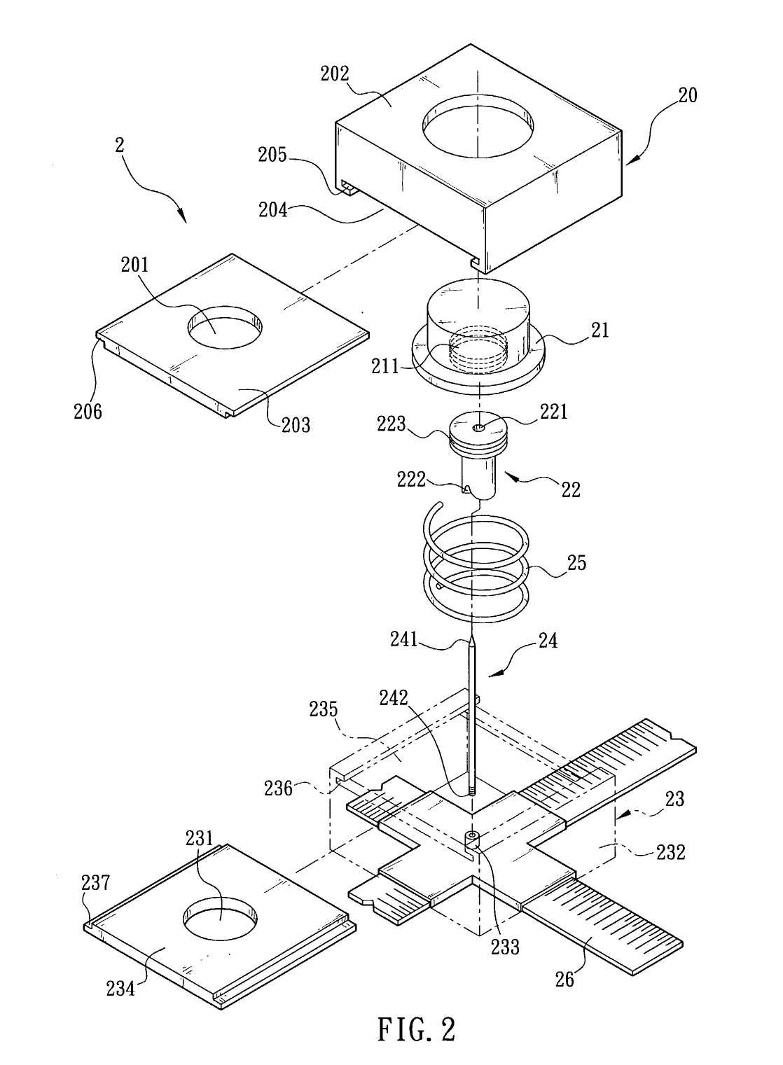

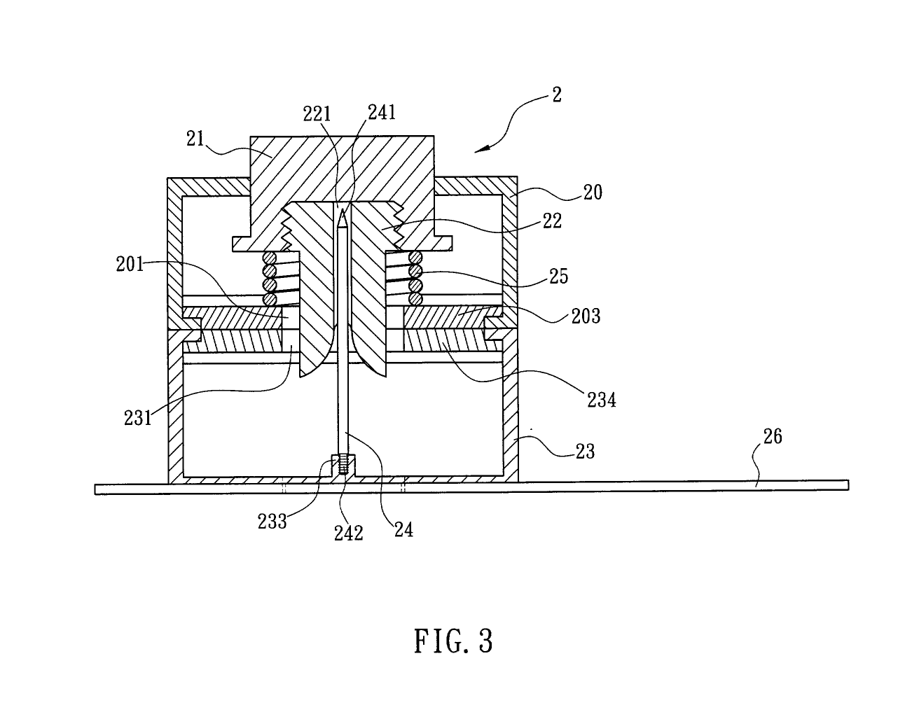

Referring to FIGS. 2 and 3, there is shown a substantially parallelepiped paper punch in accordance with the invention comprising a cover 20, a push button 21 movably projected from a top central opening of the cover 20, a first opening 201 on the bottom of the cover 20, a cutter 22 having an upper portion coupled to the push button 21, a central longitudinal hole 221 through the cutter 22, a base 23 for permitting a sheet of paper to be placed thereon, the base being coupled to the bottom of the cover 20, a second opening 231 on the top of the base 23 for permitting a lower portion of the cutter 22 to pass through, a receiving space in the base 23 in communication with the second opening 231, and a central needle 24 passed through the second opening 231, being operable to punch the sheet of paper and to secure the paper to the base 23. Referring to FIG. 3 specifically, the cutter 22 is moved as the push button 21 is pressed down. In response, the needle 24 moves into the hole 221 to activate the cutter 22 to cut the paper. As a result, the paper punching purpose is achieved.

In the invention as referring to FIG. 2 again, an elastic member (e.g., helical spring in the embodiment) 25 within the cover 20 is urged against the bottom of the push button 21. In response to a release of a force exerted on the push button 21, the elastic member 25 may expand to cause the push button 21 to return to its original position.

In the invention as referring to FIG. 2 again, the cutter 22 comprises a blade 222 at a lower end, and a thread section 223 on an upper portion. A threaded recess 211 on the bottom of the push button 21 is threadedly engageable with the thread section 223. The blade 222 may have one of a variety of sizes and shapes. As such, the cover 20 may be equipped with one of various replaceable cutters 22 by coupling the thread section 223 to the recess 211.

In the invention as referring to FIG. 2 again, the needle 24 has a pointed upper end 241 and a threaded lower end (e.g., fastening lower end) 242 for releasably (i.e., threadedly) coupling to a threaded socket 233 on the bottom of the receiving space of the base 23. As such, the needle 24 may be secured to or removed from the receiving space of the base 23.

Referring to FIG. 2 again, in a preferred embodiment of the invention the cover 20 comprises a first upper seat 202, a first removable plate 203, a bottom opening 204 facing the base 23, two opposite grooves 205 on the sides of the opening 204, and two rails 206 on the sides of the first removable plate 203 being slidingly engageable with the grooves 205. It is envisaged that a user of the paper punch can disengage the first removable plate 203 from the bottom of the cover 20 to replace a worn-out elastic member 25 due to elasticity fatigue with a new one.

Referring to FIG. 2 again, in another preferred embodiment of the invention the base 23 comprises a second upper seat 232, a second removable plate 234, a top opening 235 on the second upper seat 232 facing the cover 20, two opposite grooves 236 on the sides of the opening 235, and two rails 237 on the sides of the second removable plate 234 being slidingly engageable with the grooves 236. The second opening 231 is disposed on the top of the second removable plate 234. It is envisaged that the user can install one of various replaceable cutters 22 in the push button 21. Next, the user removes the second removable plate 234 having the second opening 231 cooperated with the cutter 22. As an end, one of different sized holes can be punched on the sheet of paper.

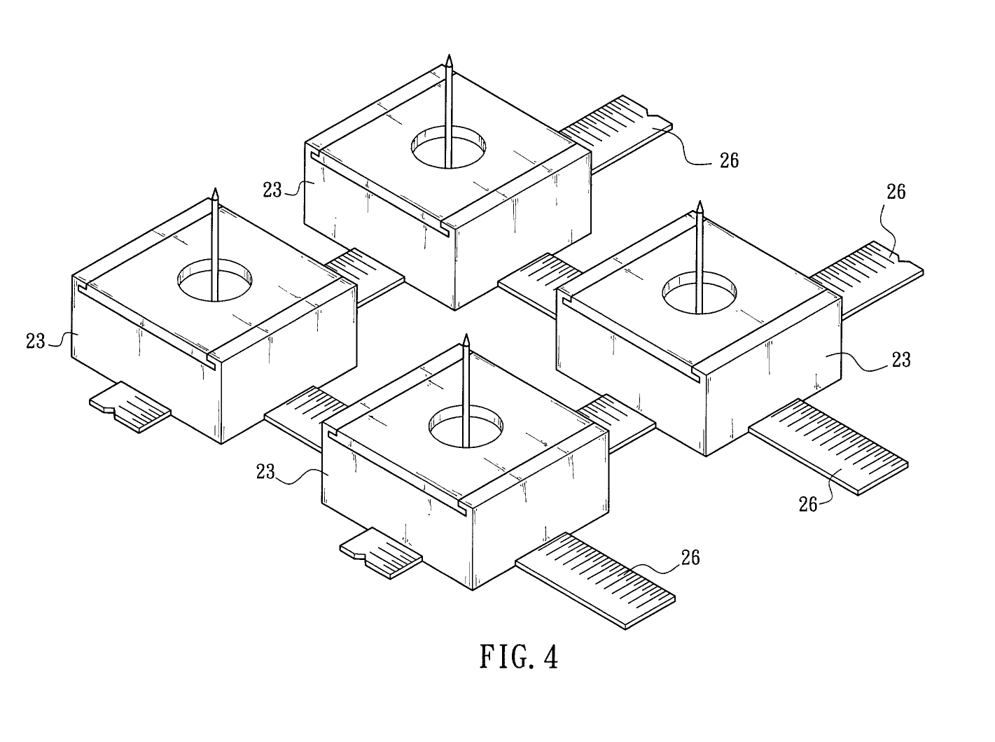

Referring to FIGS. 2 and 4, in another preferred embodiment of the invention a channel is formed on each of four bottom sides of the parallelepiped base 23 for receiving a portion of an elongate flat member 26. The elongate flat member 26 is in turn coupled to the base 23 of another identical paper punch. As an end, a plurality of holes can be punched on the paper by a plurality of paper punches. The elongate flat member 26 has a scale marked thereon. The scale can be used to adjust a spacing between any two paper punches 2 and a relative orientation therebetween depending on applications. As a result, a plurality of suitably spaced apart holes can be punched on the sheet of paper. In the embodiment, the elongate flat member 26 is a steel ruler.

While the invention has been described by means of specific embodiments, numerous modifications and variations could be made thereto by those skilled in the art without departing from the scope and spirit of the invention set forth in the claims.

What is claimed is:

1. A paper punch comprising:
a cover including a push button movably projected from the top, a first opening on the bottom, and a cutter coupled to the push button; and
a substantially parallelepiped base for permitting a sheet of paper to be placed thereon, the base being coupled to the cover, the base including a second opening on the top for permitting the cutter to pass through and a receiving space in communication with the second opening;
wherein the push button is operative to press down for moving the cutter, in response, the cutter is activated to cut the paper placed on the base, and eventually the cutter is moved into the second opening.

2. The paper punch of claim 1, wherein the cutter comprises a longitudinal hole therethrough, further comprising a central needle in the receiving space passed through the second opening, the needle being operable to punch the sheet of paper and to secure the sheet of paper to the base so that the cutter is moved as the push button is pressed down, and in response, the needle moves into the longitudinal hole to activate the cutter for cutting the sheet of paper.

3. The paper punch of claim 1, further comprising an elastic member within the cover being urged against the push button so that in response to a release of a force exerted on the push button, the elastic member is expanded to cause the push button to return to its original position.

4. The paper punch of claim 3, wherein the elastic member is a spring.

5. The paper punch of claim 1, wherein the cutter further comprises a blade at a lower end and a thread section on an upper portion, the push button comprises a threaded recess on the bottom being threadedly engageable with the thread section so that the push button is engageable with the blade selected from a group consisting of a plurality of cutters having various sizes and shapes.

6. The paper punch of claim 2, wherein the needle comprises a pointed upper end and a fastening lower end and the base further comprises a threaded socket on the bottom of the receiving space for releasably coupling to fastening lower end so that the needle is operative to either secure to or removed from the receiving space of the base.

7. The paper punch of claim 1, wherein the cover further comprises a first upper seat, a first removable plate with the first opening formed thereon, a bottom opening facing the base, two opposite first grooves on the sides of the bottom opening, and two first rails on the sides of the first removable plate being slidingly engageable with the first grooves.

8. The paper punch of claim 1, wherein the base further comprises a second upper seat, a second removable plate with the second opening formed thereon, a top opening on the second upper seat facing the cover, two opposite second grooves on the sides of the top opening, and two second rails on the sides of the second removable plate being slidingly engageable with the second grooves.

9. The paper punch of claim 1, further comprising a channel formed on each bottom side of the base and four elongate flat members each having a portion received in the channel so that one of the elongate flat members is coupled to the base of the other identical paper punch.

10. The paper punch of claim 9, wherein each elongate flat member has a scale marked thereon so that the scale is operative to adjust a spacing between two paper punches.

11. The paper punch of claim 9, wherein each elongate flat member is a steel ruler.
